(19) United States
(12) Patent Application Publication
(10) Pub. No.: US 2026/0116385 A1
(43) Pub. Date: Apr. 30, 2026

(54) STARTING A STANDSTILL VEHICLE IN ACCORDANCE WITH A START STRATEGY

(71) Applicant: VOLVO TRUCK CORPORATION, Göteborg (SE)

(72) Inventors: Robert HJELTE ULMEHAG, Göteborg (SE); Nrupathunga ASHOK, Göteborg (SE); Leo LAINE, Härryda (SE); Carl-Johan RUNDQVIST, Alingsâs (SE)

(73) Assignee: VOLVO TRUCK CORPORATION, Göteborg (SE)

(21) Appl. No.: 19/116,712

(22) PCT Filed: Sep. 30, 2022
(86) PCT No.: PCT/EP2022/077398

§ 371 Date: Mar. 28, 2025

(51) Int. Cl. B60W 30/18; B60G 17/04; B60W 10/04; B60W 10/22

(52) U.S. Cl. CPC B60W 30/18009; B60G 17/04; B60W 10/04; B60W 10/22; B60G 2500/30; B60W 2300/14; B60W 2520/04; B60W 2520/10; B60W 2530/10; B60W 2710/22

(57) ABSTRACT

A method for starting a standstill vehicle in accordance with a start strategy includes obtaining suspension capabilities of a suspension arrangement in the vehicle. The suspension capabilities is indicative of at least a maximum vertical load that can be applied to a driven axle of the vehicle. In a suspension control step, issue suspension operation information to the vehicle to operate the suspension arrangement in accordance with the suspension capabilities to increase the vertical load applied to said driven axle of the vehicle. In a propulsion control step. issue propulsion control information to the vehicle to apply a propulsion longitudinal force on the wheels of the driven axle of the vehicle. When detecting the vehicle does not follow the start strategy, repeat the suspension control step and the propulsion control step.

### TECHNICAL FIELD

The disclosure relates generally to starting strategies of vehicles. In particular aspects, the disclosure relates to starting a standstill vehicle in accordance with a start strategy. The disclosure can be applied in heavy-duty vehicles, such as trucks, buses, and construction equipment. Although the disclosure may be described with respect to a particular vehicle, the disclosure is not restricted to any particular vehicle.

### BACKGROUND

A vehicle can in certain situations have a problem starting from a standstill, for example when the vehicle is located on a slippery surface such as ice, snow, mud, etc.

To alleviate the problem, a skilled driver can have a starting strategy for how to get the standstill vehicle driving forward. The strategy may be developed by the driver to account for the nature of the surface of the vehicle and may account for expert knowledge of the particular vehicle. To propel the vehicle forward, the driver may try different combinations of steering wheel angles and accelerations requests.

Regardless of the start strategy, the vehicle may still not be able to move, and hence, a problem arises in how to improve starting strategies of vehicles.

### SUMMARY

An object of the invention is to improve a starting strategy of a standstill vehicle.

According to a first aspect of the disclosure, a computer-implemented method for starting a standstill vehicle in accordance with a start strategy is provided. Said vehicle has a vehicle longitudinal extension in a vehicle longitudinal direction and a vehicle vertical extension in a vehicle vertical direction. Said vehicle longitudinal direction corresponds to an intended direction of travel of said vehicle when travelling straight ahead. Said vehicle vertical direction corresponds to a direction of a normal to a planar surface supporting the vehicle. The computer-implemented method comprises, by a processor device of a computer system, obtaining suspension capabilities of a suspension arrangement in the vehicle. The suspension capabilities is indicative of at least a maximum vertical load, in said vertical direction, that can be applied to a driven axle of the vehicle. The computer-implemented method further comprises, by the processor device, in a suspension control step, issuing suspension operation information to the vehicle to operate the suspension arrangement in accordance with the suspension capabilities to increase the vertical load applied to said driven axle of the vehicle. The computer-implemented method further comprises, by the processor device, in a propulsion control step, issuing propulsion control information to the vehicle to apply a propulsion longitudinal force, in said longitudinal direction, on the wheels of the driven axle of the vehicle. The computer-implemented method further comprises, in response to detecting that the vehicle does not follow the start strategy, repeating the suspension control step and the propulsion control step.

The first aspect of the disclosure may seek to improve the starting of the standstill vehicle. In other words to improve chances of a successful start of the vehicle.

A technical benefit may include improved starting of the standstill vehicle. This is due to improved traction of the driven axle of the vehicle. The traction is improved since the suspension control step issues the suspension operation information to which increase the vertical load applied to said driven axle of the vehicle. Then, when issuing the propulsion control information in the propulsion control step, applying the longitudinal force will have greater traction as the suspension allows for an increased vertical load while applying the longitudinal force. As the longitudinal force is applied when the vertical load is increased, this achieves an improved chance for starting the vehicle in terms of changing the vehicle's condition from a stationary condition to a moving condition. Furthermore, as when the vehicle has not followed the start-strategy, i.e. is still standstill, as the suspension control step and the propulsion control step is repeated, further chances of starting the vehicle is achieved.

In some examples, the suspension control step comprises operating the suspension arrangement in accordance with the suspension capabilities to increase the vertical load applied such that the vertical load applied to said driven axle varies in accordance with a function of time.

A technical benefit may include improved starting of the standstill vehicle. This is since when the vertical load applied to said driven axle is varied in accordance with the function of time, each variation of the vertical load achieves traction of the driven axle. The propulsion step can be performed with traction over a longer period of time and thereby improves chances of starting the vehicle.

In some examples, the vertical load applied to said driven axle varies as a function of time with a time period such that a vertical load function with crests and troughs is obtained, preferably said time period defined as the time between two adjacent crests.

A technical benefit may include improved starting of the standstill vehicle. This is since the variations of crests allow for more traction of the vehicle over time and thereby allows for the propulsion step to be performed with traction over a longer period of time and thereby improves chances of starting the vehicle.

In some examples, the time period dependent on an actuation rate of the suspension arrangement. A technical benefit may include improved time of traction of the vehicle. This is since when the suspension is varied quickly, with the actuation rate, the vertical load of the vehicle will always achieve traction on the vehicle to allow for the propulsion step to apply longitudinal force with traction to the road surface.

In some examples, the function of time is associated with an amplitude of vertical load to apply to said driven axle. In these examples, the amplitude corresponds to half the difference in vertical load between a crest load at one of the crests and a trough load at one of the troughs. In some examples, the amplitude is based on a minimum amplitude needed to apply an increased vertical load to said driven axle.

A technical benefit may include allowing for increased time of traction for the vehicle. This is since the vertical load applied with the function of time can be applied with a limit corresponding to the maximum vertical load of the suspension capabilities. When the amplitudes indicate smaller vertical load than the maximum vertical load, the function of time can be applied over a longer period of time and thus improve traction of the vehicle.

In some examples, the function of time is indicative of a duration for how long to apply the increased vertical load to said driven axle.

A technical benefit may include improved starting of the standstill vehicle. This is since the propulsion step can be synchronized to be applied for the duration of the application of the vertical load, thus improving traction when applying the longitudinal force on the wheels of the driving axle.

In some examples, the function of time is associated with an average value being the average of the vertical load applied to the vertical load applied to said driven axle. In these examples, said suspension control step comprises increasing the average value.

In some examples, said suspension control step comprises maintaining the amplitude when issuing suspension operation information to the vehicle to operate the suspension arrangement in accordance with the suspension capabilities to increase a vertical load applied to said driven axle of the vehicle.

In some examples, the function of time is a predefined function of time.

A technical benefit may include improved starting of the standstill vehicle. This may be in scenarios when it is not possible to efficiently determine the function of time dynamically. Instead, the function of time may be analyzed and optimized prior to assembly of the vehicle and may be tuned to all parts of the vehicle.

In some examples, the method further comprises determining the function of time based on any one or more of: a load of the vehicle, an indication of whether or not the vehicle is attached to a trailer, a surface type of the ground supporting ground engaging members, such as wheels, associated with said driven axle, and the suspension capabilities and/or an indication of a type of suspension in the suspension arrangement.

A technical benefit may include improved starting of the standstill vehicle. This may be in scenarios when dynamic parameters of the vehicle are more important than what can be tuned in advance. For example, it may be possible to account dynamically for the load of the vehicle which affects the vertical load on the driven axle.

In some examples, issuing suspension operation information to the vehicle to operate the suspension arrangement comprises issuing suspension operation information to control a flow of pressurized air of the suspension arrangement in accordance with the function of time.

A technical benefit may include improved starting of the standstill vehicle. This is since when issuing suspension operation information to control a flow of pressurized air of the suspension arrangement, it is possible to control the vertical load of the driven axle using finer grained control, thus allowing for a smaller amplitude for the function of time than what is possible when performing suspension control through a normal suspension interface is limited by a dead band limit. The dead band limit is a threshold which needs be exceeded before a controller of the suspension arrangement triggers a suspension stroke for normal driving events. As the amplitude can be smaller and more fine-grained by controlling the flow of pressurized air of the suspension arrangement, it is possible to achieve a smallest suspension stroke movement of the suspension arrangement which still produces a high enough vertical load for a given sprung mass, e.g., higher than a threshold. The smallest suspension stroke movement may be predefined or determined dynamically based on the suspension capabilities.

In some examples, said propulsion control step comprises applying the propulsion longitudinal force on the wheels of the driven axle of the vehicle based on the function of time. Purely by way of example, if the vertical load applied to the driven axle varies in accordance with the function of time such that the vertical load is higher in a first time range than the vertical load in a second time range, the propulsion control step may correspondingly comprise applying a higher propulsion longitudinal force in the first time range than in the second time range.

A technical benefit may include improved starting of the standstill vehicle. This is since the propulsion step can be synchronized to be applied for the duration of the application of the vertical load, thus improving traction when applying the longitudinal force on the wheels of the driving axle.

In some examples, the method further comprises, prior to any one or both of the suspension control step and the propulsion control step, issuing lowering information to the vehicle, to trigger a lowering of a chassis of the vehicle.

A technical benefit may include improved starting of the standstill vehicle. This is since the lowering of the chassis leads to an increase in the maximum vertical load that can be applied to a driven axle of the vehicle, thus allowing more time for the function of time to apply vertical loads to the driven axle.

In some examples, the vehicle is attached to a trailer. In some of these examples, the method further comprises, by the processor device, prior to any one or both of the suspension control step and the propulsion control step, issuing trailer suspension operation information to the trailer to operate a suspension arrangement of the trailer to impose an increased vertical load on said driven axle of the vehicle.

A technical benefit may include improved starting of the standstill vehicle. This is since the trailer imposes the increased vertical load on said driven axle of the vehicle.

In some examples, the suspension capabilities is further indicative of a time duration during which a certain vertical load is allowed to be applied to the driven axle of the vehicle.

In some examples, issuing the suspension operation information to the vehicle in the suspension control step, and/or wherein obtaining the suspension capabilities is performed by issuing respective requests to a suspension runtime interface of the vehicle.

In some examples, said start strategy comprises that the vehicle moves at a speed being equal to, or exceeding a predetermined threshold speed, preferably said predetermined threshold speed is in the range of 5-15 km/h.

According to a second aspect of the disclosure, a computer system comprising the processor device configured to perform the computer-implemented method of the first aspect is provided. The second aspect of the disclosure may seek to improve starting of a standstill vehicle. A technical benefit may include the same and/or corresponding advantages as achieved by the method of the first aspect.

According to a third aspect of the disclosure, a vehicle comprising the processor device configured to perform the computer-implemented method of the first aspect is provided. The third aspect of the disclosure may seek to improve starting of a standstill vehicle. A technical benefit may include the same and/or corresponding advantages as achieved by the method of the first aspect.

In some examples, the vehicle is attached to a trailer, and wherein the processor device is capable of controlling a suspension arrangement of the trailer.

A technical benefit may include improved starting of the standstill vehicle. This is since it is thereby possible to operate the suspension arrangement of the trailer to impose an increased vertical load on said driven axle of the vehicle.

According to a fourth aspect of the disclosure, a computer program product is provided. The computer program product comprises program code for performing, when executed by the processor device the computer-implemented method of the first aspect. The fourth aspect of the disclosure may seek to improve starting of a standstill vehicle. A technical benefit may include the same and/or corresponding advantages as achieved by the method of the first aspect.

According to a fifth aspect of the disclosure, a control system is provided. The control system comprises one or more control units configured to perform the computer program product of the fourth aspect. The fifth aspect of the disclosure may seek to improve starting of a standstill vehicle. A technical benefit may include the same and/or corresponding advantages as achieved by the method of the first aspect.

According to a sixth aspect of the disclosure, a non-transitory computer-readable storage medium control system is provided. The non-transitory computer-readable storage medium comprises instructions, which when executed by the processor device, cause a processor device to perform the computer-implemented method of the first aspect. The sixth aspect of the disclosure may seek to improve starting of a standstill vehicle. A technical benefit may include the same and/or corresponding advantages as achieved by the method of the first aspect.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIG. 1 is an exemplary vehicle according to one example.

FIG. 2 is an exemplary vehicle according to another example.

FIG. 3 is an exemplary flowchart of a method according to an example.

FIG. 4 is an exemplary block diagram illustrating an exemplary vehicle motion management module according to an example.

FIGS. 5a-c are example line diagrams illustrating a function of time.

FIG. 6 is a schematic diagram of an exemplary computer system for implementing examples disclosed herein, according to one example.

### DETAILED DESCRIPTION

Aspects set forth below represent the necessary information to enable those skilled in the art to practice the disclosure.

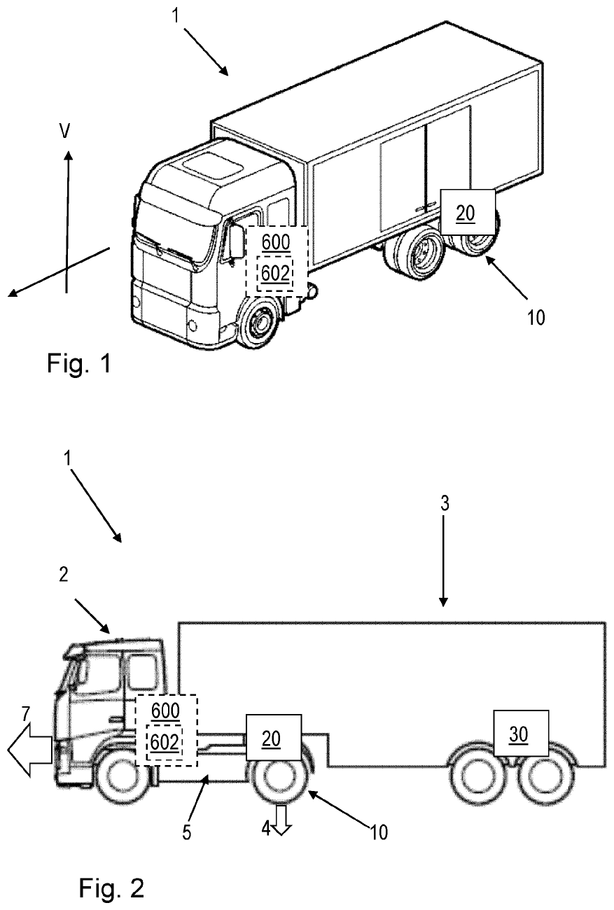

FIG. 1 illustrates a vehicle 1 according to one example. The vehicle 1 is a standstill vehicle. The vehicle 1 may be any suitable type of vehicle, e.g., heavy-duty vehicles, such as trucks, buses, and construction equipment. The vehicle may be attached to any suitable type of trailer. As indicated in FIG. 1, the vehicle 1 has a vehicle longitudinal extension in a vehicle longitudinal direction L and a vehicle vertical extension in a vehicle vertical direction V. The vehicle longitudinal direction L corresponds to an intended direction of travel of the vehicle 1 when travelling straight ahead and the vehicle vertical direction V corresponds to a direction of a normal to a planar surface supporting the vehicle 1.

The vehicle 1 may be arranged on a surface which have low friction and wherein the vehicle 1 may have a difficulty gaining traction and can therefore not start efficiently or successfully. The vehicle 1 may comprise a suspension arrangement 20 for providing suspension to the vehicle 1, in particular to a driven axle 10 of the vehicle 1. While FIG. 1 illustrates that the driven axle 10 is the rear axle, while this may be a common scenario, the driven axle 10 may also be any suitable axle of the vehicle 1 which is capable of applying a propulsion longitudinal force, in said longitudinal direction, on the wheels of said axle of the vehicle 1. When the vehicle 1 is driven by multiple axles, the driven axle 10 may comprise one or more of these axles.

Embodiments herein comprises obtaining suspension capabilities of the suspension arrangement 20. The suspension capabilities is indicative of at least a maximum vertical load that can be applied to a driven axle. However, any suitable parameter comprising a capability, metric, and/or status of each suspension for a wheel and/or axle may be obtained. For example, for each suspension, e.g., for an axle or wheel, it may be possible to obtain potential, limits such as min/max, and/or current values in the suspension arrangement 20 of any one or more of:
a force or load, e.g., a current, a minimum, and/or a maximum force or load,
a level, e.g., a current, a minimum, and/or maximum level,
a stiffness, e.g., a current, a minimum, and/or a maximum stiffness,
a status, e.g., a current,
an extension rate, e.g., a current, a minimum, and/or a maximum extension rate,
a compression rate, e.g., a current, a minimum, and/or a maximum compression rate,
a damping, e.g., a current, a minimum, and/or a maximum.

Embodiments herein issues, in a suspension control step, suspension operation information to the vehicle 1 to operate the suspension arrangement 20 in accordance with the suspension capabilities to increase the vertical load applied to said driven axle 10 of the vehicle 1. Embodiments herein may limit the maximum vertical load such that the vertical load can be varied in steps of multiple vertical loads as a function of time. Furthermore, embodiments herein may apply a propulsion longitudinal force on wheels of the driven axle 10 of the vehicle 1. In this way, better traction can be attained as the propulsion can be applied when the vertical force is increased, and the traction of the vehicle is improved. As the traction is improved, the vehicle 1 can start efficiently and with higher chances.

Obtaining the suspension capabilities and/or operating the suspension arrangement by issuing suspension operation information may be performed by signalling a suspension runtime interface of the suspension arrangement 20, also referred to as an Individual external Suspension Request (IXSUSR). The suspension runtime interface may be a real-time interface and thereby limited by real-time constraints such that a request is arranged to always be responded within a predefined amount of time, e.g., 1 millisecond.

Using the suspension runtime interface it may be possible to request virtual forces and/or loads to be applied to the vehicle, e.g., a vertical load and/or an increase in a vertical load. When a virtual force such as vertical load is requested on the vehicle 1, the runtime interface determines the suspension stroke actuation necessary to achieve the requested virtual force, and e.g., will acuate the suspensions accordingly within the predefined amount of time.

As an example, the suspension runtime interface may be used to implement a functional safety in the form of fail silent. For example, when the suspension capabilities shows indicates no increase in vertical load available, it may be possible to re-allocate current applied loads to improve a situation, e.g., to improve traction.

As another example, the suspension runtime interface may be used to obtain a time it takes for a request to be processed, e.g., the predefined amount of time.

As another example, the suspension runtime interface may be used to obtain which forces, loads, and/or moments can be used in the suspension arrangement 20 and/or imposed on the vehicle 1.

The suspension runtime interface may provide any suitable information from the suspension arrangement 20 to a Vehicle Motion Management (VMM) module of the vehicle 1. The VMM module may be used as an interface to request motions of the vehicle such as the suspension and other motions, e.g., including propulsion forces. The VMM module may be used to obtain any other motion status of the vehicle 1 and/or to request to apply forces to the vehicle 1. The VMM module may comprise aggregated information of all motions and status, e.g., including any one or more out of suspension, braking, steering, propulsion, etc.

The VMM module may communicate with the suspension runtime interface as defined above for the suspension, and corresponding runtime interfaces for other parameters, e.g., relating to braking, propulsion, etc. As the VMM is communicatively coupled with different interfaces such as the suspension runtime interface, the VMM module has real-time information available in a standardized format which can be used to impose quick, accurate and efficient suspension actuation of the suspension arrangement 20 to influence the motion of the vehicle 1 to improve safety, handling and comfort. In other words, the VMM module may in some embodiments at least partly control the above-mentioned suspension runtime interface and/or other corresponding runtime interfaces for other vehicle functionalities than suspension, e.g., speed/propulsion, braking, etc.

Embodiments herein may be performed at least partly by a computer system 600, such as by a processor device 602 comprised therein. The suspension arrangement 20 may be controlled by suspension operation information issued by the processor device 602. Additionally or alternatively, embodiments herein may at least partly be performed/requested by use of the VMM module and/or the above-mentioned suspension runtime interface. The propulsion longitudinal force on wheels of the driven axle 10 of the vehicle 1 may be controlled by propulsion control information issued by the processor device 602. The propulsion longitudinal force may be requested by use of the VMM module, e.g., by a similar interface to the suspension runtime interface discussed above but for propulsion forces on wheels of the vehicle 1.

The computer system 600 may be comprised in any suitable location, e.g. in the vehicle 1, or external to the vehicle 1. The computer system 600 may be communicatively coupled with the suspension arrangement 20 and/or any other suitable units of the vehicle 1.

FIG. 2 is another example of the vehicle 1 and may further be seen as another view of FIG. 1, according to another example. In this example, the vehicle 1 comprises a tractor 2. The vehicle 1 is attached to a trailer 3. The trailer 3 is pulled by the tractor 2.

As discussed in FIG. 1, operating the suspension arrangement 20 in accordance with the suspension capabilities to increase the vertical load applied to said driven axle 10 of the vehicle 1 may comprises applying the vertical load 4 to the driving axle 10. This allows improved traction to the wheels of the driven axle 10 and results in improved starting of the vehicle 1 when applying the propulsion longitudinal force on the wheels of the driven axle 10. When successful, the vehicle 1 may have longitudinal motion 7, e.g., larger than a threshold, and then the embodiments herein may cease.

The vehicle 1 may comprise a chassis 5. To improve the suspension capabilities of the suspension arrangement, e.g., the maximum vertical load applicable by the suspension arrangement 20, the chassis 5 can be lowered. This compresses suspensions of the suspension arrangement 20 such that more extension is available to apply vertical load on the driven axle 10.

The trailer 3 may comprise a suspension arrangement 30. The trailer suspension arrangement 30 may be capable of operate to impose an increased vertical load on said driven axle 10 of the vehicle 1. This may be achieved by extending suspensions of the suspension arrangement 30, e.g., suspensions of a rear part of the trailer 3, thus pivoting a load on the tractor 2 and the driving axle 10. The suspension arrangement 30 may be controlled by suspension operation information e.g., issued by the processor device 602. Additionally or alternatively, the suspension arrangement 30 may be controlled at least partly by the above-mentioned suspension runtime interface and/or the VMM module.

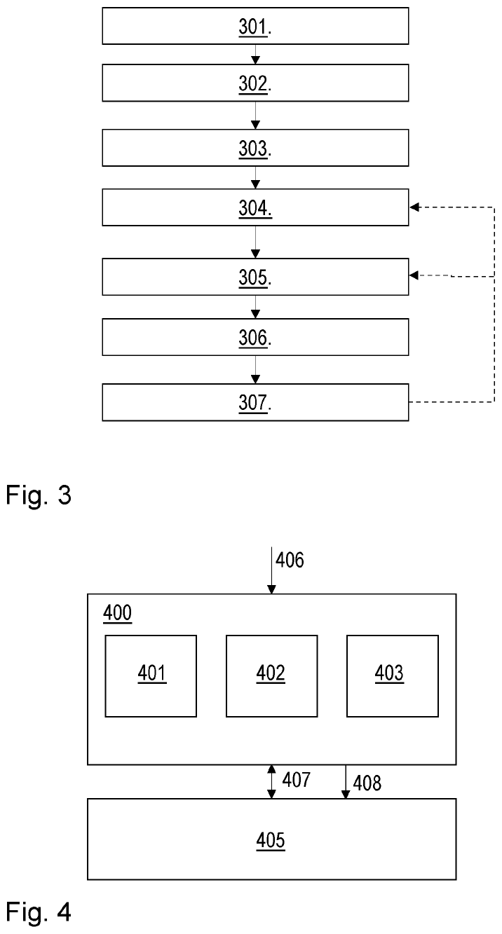

FIG. 3 is a flow chart of an example computer-implemented method for starting a standstill vehicle, i.e. the vehicle 1, in accordance with a start strategy. Said vehicle has a vehicle longitudinal extension in the vehicle longitudinal direction V and a vehicle vertical extension in the vehicle vertical direction V. Said vehicle longitudinal direction L corresponds to an intended direction of travel of said vehicle when travelling straight ahead. Said vehicle vertical direction V corresponds to a direction of a normal to a planar surface supporting the vehicle. The method comprises any one or more of the following actions 301-307. The actions may be taken in any suitable order. The start strategy may be to perform any suitable actions of actions 301-307 iteratively until the start strategy has been successful, e.g., when detected that the vehicle 1 is not standstill, e.g., when the vehicle 1 has a longitudinal speed/velocity above a predefined threshold. In some embodiments, said start strategy, i.e. a successful start strategy, comprises that the vehicle 1 moves at a speed being equal to, or exceeding a predetermined threshold speed, preferably said predetermined threshold speed is in the range of 5-15 km/h. Dashed boxes in FIG. 3 may be optional.

### Action 301—Suspension Capabilities

The method comprises, by the processor device 602 of the computer system 600, obtaining suspension capabilities of the suspension arrangement 20 in the vehicle 1. The suspension capabilities is indicative of at least a maximum vertical load, in said vertical direction V, that can be applied to a driven axle 10 of the vehicle 1. Any one or more other suitable capabilities and/or status of the suspension arrangement 20 may be obtained as part of the suspension capabilities. In embodiments when the vehicle 1 is attached to a trailer, the suspension capabilities may comprise status and/or capabilities of the trailer suspension arrangement 30.

For example, the suspension capabilities may indicate any one or more of:
a force or load, e.g., a current, a minimum, and/or a maximum force or load,
a level, e.g., a current, a minimum, and/or maximum level,
a stiffness, e.g., a current, a minimum, and/or a maximum stiffness,
a status, e.g., a current,
an extension rate, e.g., a current, a minimum, and/or a maximum extension rate,
a compression rate, e.g., a current, a minimum, and/or a maximum compression rate,
a damping, e.g., a current, a minimum, and/or a maximum.

The suspension capabilities may further be indicative of a time duration during which a certain vertical load is allowed to be applied to the driven axle 10 of the vehicle 1.

The suspension capabilities may be indicative of an aggregated capability of the suspension arrangement 20 and/or suspension capabilities, e.g., as defined above, of one or more respective individual suspensions in the suspension arrangement 20.

In some embodiments, obtaining the suspension capabilities, is performed by issuing respective requests to the suspension runtime interface of the vehicle 1. In other words, obtaining the suspension capabilities may comprise sending a request to the above-mentioned runtime interface, e.g., as part of the VMM module of the vehicle 1.

### Action 302—Lowering Chassis

In some embodiments, prior to any one or both of the suspension control step and the propulsion control step as will be described with respect to action 304, the method comprises issuing lowering information to the vehicle 1, to trigger a lowering of a chassis 5 of the vehicle 1. As the chassis 5 is lowered, it follows that more stroke capacity is available as part of the suspension capabilities. Action 302 may be performed before action 301 and/or the increased suspension capabilities may be accounted for in the obtained suspension capabilities.

### Action 303—Trailer Suspension

In some embodiments when the vehicle 1 is attached to a trailer 3, the method further comprises, by the processor device 602, prior to any one or both of the suspension control step and the propulsion control step, e.g., as will be described in action 303-304, issuing trailer suspension operation information to the trailer to operate a suspension arrangement 30 of the trailer to impose an increased vertical load on said driven axle 10 of the vehicle 1. In other words, the suspension arrangement 30 of the trailer may extend the suspensions of the rear part of the trailer to pivot the trailer load on the driven axle of the driven axle 10. This increases the vertical load on the driven axle 10.

### Action 304—Suspension Control Step

The method comprises, by the processor device 602, in a suspension control step, issuing suspension operation information to the vehicle 1 to operate the suspension arrangement 20 in accordance with the suspension capabilities to increase the vertical load applied to said driven axle 10 of the vehicle 1. The issuing of the suspension control information to the vehicle 1 may comprise sending a request to the above-mentioned suspension runtime interface, e.g., as part of the VMM module.

In some embodiments, the suspension control step comprises operating the suspension arrangement 20 in accordance with the suspension capabilities to increase the vertical load applied such that the vertical load applied to said driven axle 10 varies in accordance with a function of time. In other words, instead of applying the maximum vertical load as indicated to be available by the suspension capabilities, a burst of smaller vertical loads may be applied to the driven axle 10, e.g., in a periodical/recurring manner such as by pulsating the suspensions of the driven axle 10 until the suspension capabilities have been depleted. In this way, instead of loading the driven axle 10 with the maximum vertical load in as one event, it is possible to distribute the vertical loads over a longer period of time to achieve traction of the driven axle 10 for as long as possible and thereby increase chances of moving the vehicle 1 when applying propulsion forces on the wheels of the driven axle 10.

In some embodiments, the vertical load applied to said driven axle 10 varies as a function of time with a time period such that a vertical load function with crests and troughs is obtained.

The function of time may define when the vertical load is to be applied to the driven axle 10. Additionally or alternatively, the function of time may define when the suspension arrangement 20 is to be actuated to achieve the vertical load to be imposed on the driven axle 10.

In a preferred embodiment, said time period is defined as the time between two adjacent crests In some embodiments, the time period is dependent on an actuation rate of the suspension arrangement 20. The actuation rate may be a speed of how fast it may be possible or allowable to apply vertical forces using the suspension arrangement 20 and/or by using the suspension runtime interface. In other words, the function of time may vary based on how fast it is possible to adjust and/or apply the vertical load.

The crests and troughs of said function of time may e.g., be defined by, and/or indicate, any suitable predefined or dynamically defined parameter, e.g., amplitude, periodicity, frequency, etc.

Said function of time may be modelled by any suitable function such as a pulsating function, e.g., a pulse wave or any other suitable periodic/recurring function.

In some embodiments, the function of time is associated with an amplitude of vertical load to apply to said driven axle 10. The amplitude may correspond to half the difference in vertical load between a crest load at one of the crests and a trough load at one of the troughs.

Additionally or alternatively, the amplitude may be of an actuation to be performed by the suspension arrangement, e.g., how long to actuate a suspension and/or how much suspension stroke to apply, e.g., 10-12 mm.

In some embodiments, the amplitude is based on a minimum amplitude needed to apply an increased vertical load to said driven axle 10. For example, the amplitude may correspond to a vertical load produced by a suspension actuated with a stroke equal to a dead band limit of the suspension arrangement 20. Alternatively the amplitude may correspond to a vertical load produced by controlling a flow of pressurized air in pneumatic suspensions of the suspension arrangement 20.

In some embodiments, the function of time is indicative of a duration for how long to apply the increased vertical load to said driven axle 10.

In some embodiments, e.g., as part of when the function of time increases the vertical load in a varied manner as described in multiple different combinable embodiments above, the function of time is associated with an average value being the average of the vertical load applied to the vertical load applied to said driven axle 10. In these embodiments, said suspension control step comprises increasing the average value.

In some embodiments, said suspension control step comprises maintaining the amplitude when issuing suspension operation information to the vehicle to operate the suspension arrangement in accordance with the suspension capabilities to increase a vertical load applied to said driven axle of the vehicle.

In some embodiments, the function of time is a predefined function of time. In other words, there is a predefined burst on how to apply the vertical load, e.g., a predefined vertical load performed repeatedly with a predefined periodicity.

In some embodiments, the method comprises determining the function of time based on any one or more of:
a load of the vehicle 1, e.g., the load affecting a constant vertical load applied to the vehicle 1 and/or the driven axle 10,
an indication of whether or not the vehicle 1 is attached to a trailer, e.g., when attached to the trailer 1, the trailer may apply a vertical load on the driven axle 10,
a surface type of the ground supporting ground engaging members, such as wheels, associated with said driven axle 10, e.g., different surface types may need more or less frequent amount of vertical load in combination with propulsion, e.g., different surface type may need a higher vertical load on the driven axle 10, and
the suspension capabilities and/or an indication of a type of suspension in the suspension arrangement 20, the suspension type may indicate which type of function is needed, e.g., it may be predetermined that some suspension types perform better for certain frequencies, the amplitude and frequency may be defined based on how much capabilities are available, the amplitude and frequency may change per iteration when the start strategy is performed iteratively.

In some embodiments, issuing suspension operation information to the vehicle 1 to operate the suspension arrangement 20 comprises issuing suspension operation information to control a flow of pressurized air of the suspension arrangement 20 in accordance with the function of time. For some of these embodiments, issuing the suspension operation information comprises requesting a valve open time of a valve controlling the flow of pressurized air in the suspension arrangement 20. The valve open time and frequency may be based on the function of time. In these embodiments, the function of time and/or the valve open time may depend on any one or more out of the following parameters, e.g., as obtained and/or determined by embodiments herein, e.g., by use of the VMM module and/or the above-mentioned suspension runtime interface:
Q: a valve flow rate which depends on a suspension bellow pressure of the suspension arrangement 20, and available system pressure of the suspension arrangement 20, e.g., as part of the obtained suspension capabilities,
V: a suspension stroke rate depending on Q and a bellow area of the suspension arrangement 20, e.g., as part of the obtained suspension capabilities,
t: a time taken to reach the stroke rate V from 0 stroke rate, e.g., a constant time may vary with Q for air due to compressibility, e.g., as part of the suspension capabilities,
A=V/t: an acceleration of a suspension in the suspension arrangement 20 for the driven axle 10, e.g., an average acceleration, e.g., as part of the suspension capabilities, and
F=m.A: reaction force on ground, e.g., as part of the suspension capabilities and/or determined based on the above parameters.

For the above-mentioned parameters, time t may be used to limit the frequency of bursts, Reaction force F may indicate whether the function of time can produce enough traction for the driven axle 10, e.g., the function of time and/or the above mentioned parameters may be adjusted and/or controlled until F is above a predefined threshold.

In some embodiments, the time t may be determined, or a burst frequency as a function of t may be determined, with F reaction force, e.g., to be used to define the function of time. These one or more parameters may be provided to the suspension runtime interface discussed above with respect to the vehicle 1, which will request the corresponding actuated suspension on the driven axle.

### Action 305—Propulsion Control Step

The method comprises, by the processor device 602, in a propulsion control step issuing propulsion control information to the vehicle 1 to apply a propulsion longitudinal force, in said longitudinal direction L, on the wheels of the driven axle 10 of the vehicle 1. The issuing of the propulsion control information to the vehicle 1 may comprise sending a request to a propulsion runtime interface, e.g., as part of the VMM module of the vehicle 1.

In some embodiments, said propulsion control step comprises applying the propulsion longitudinal force on the wheels of the driven axle 10 of the vehicle 1 based on the function of time. In other words, applying the propulsion longitudinal force on the wheels of the driven axle 10 of the vehicle 1 may be synchronized with the suspension control step, i.e. such that the propulsion longitudinal force on the wheels of the driven axle 10 of the vehicle 1 is applied when the vertical load is applied to the driven axle. I.e. the propulsion longitudinal force on the wheels of the driven axle 10 of the vehicle 1 may also vary with the function of time.

Purely by way of example, if the vertical load applied to the driven axle varies in accordance with the function of time such that the vertical load is higher in a first time range than the vertical load in a second time range, the propulsion control step may correspondingly comprise applying a higher propulsion longitudinal force in the first time range than in the second time range.

### Action 306—Detect Successfulness of Start Strategy

The method comprises, detecting that the vehicle 1 does not follow the start strategy. Detecting that the vehicle 1 does not follow the start strategy may comprise detecting that the vehicle 1 remains standstill or at least has a longitudinal motion of less than a predefined threshold. In contrast, when detecting that the vehicle 1 has a longitudinal motion, e.g. a speed or velocity, above a predefined threshold, the start strategy is successful, i.e. the vehicle 1 follows the start strategy, and no further actions is needed. In some of these embodiments when the start strategy is successful, the method may further comprise issuing raiding information to the vehicle 1, to trigger a raiding of the chassis 5 of the vehicle 1. The chassis 5 may e.g., be raised to a previous height, to a maximum height, and/or a predefined height.

### Action 307—Repeating Steps

The method comprises, in response to detecting that the vehicle 1 does not follow the start strategy, repeating the suspension control step as in action 305 and the propulsion control step as in action 305. Additionally or alternatively, any one or more actions 301-307, in any suitable order, may be iterated until the start strategy is deemed to be successful. In addition to repeating the suspension control step of action 305 and/or the other actions, the method may comprise issuing suspension operation information to the vehicle 1 to operate the suspension arrangement 20 to extend at least part of suspensions in the suspension arrangement 20 such that the suspension capabilities are increased to be capable of applying further vertical loads, e.g., to be able to repeat the actions. The suspension capabilities may be updated accordingly or obtained again as in action 301.

FIG. 4 is a block diagram indicating an example scenario using a VMM module 400 in the vehicle 1. The VMM Module 400 may comprise a first sub-module 401 for motion estimation, a second module 402 for motion prediction, and a third sub-module 403 for motion coordination. The second sub-module 402 may control levelling of axles/wheels for certain situations and predictions thereof, e.g., as in embodiments herein. The VMM module 400 may communicate with a suspension runtime interface 405, e.g., an iXSUSR interface such as the suspension runtime interface discussed with respect to embodiments above. The VMM module 400 may be part of and/or controlled by the computer system 600 such as by the processor device 602. The VMM module may control any suitable motion of the vehicle 1, and/or may predict/determined any motion of the vehicle 1.

In an example scenario, to illustrate some capabilities of the VMM module 400, the VMM module 400 may obtains 406 an indication of that the vehicle 1 is in a standstill, e.g., due to slippery conditions, stuck in mud, etc. The indication may be obtained as input from a user and/or obtained by sensors of the vehicle 1.

To start the vehicle 1, the VMM module 400 may initiate the start strategy as described by above actions 301-307. First, the VMM module 400 may request and receive 407 suspension capabilities of the suspension runtime system, e.g., as in action 401, based on the suspension capabilities, the VMM module 400 may determine which vertical loads to apply to the driven axle 10 of the vehicle 1, and/or how the vertical load shall be varied with the function of time, whether the chassis 5 shall be lowered, and/or whether the trailer suspension 30 shall be actuated, etc. e.g., as in actions 302-304. The VMM module 400 may then request 408 the suspension runtime interface to apply the determined vertical load, e.g., varied with the function of time, e.g., as in action 304.

Embodiments herein may be performed within a system for handling vehicle motion management, wherein said system is handling either force or torque based requests defined as v=[Fzvehicle, Mpitch, Mroll], and may be performed by issuing instructions to the VMM module 400. Fzvehicle may be a yaw motion, e.g., a yaw rate, of the vehicle 1. Mpitch may be a pitch motion, e.g., a pitch rate, of the vehicle 1. Mroll may be a roll motion, e.g., a roll rate, of the vehicle 1.

Virtual vertical forces and/or virtual torque via suspension in the suspension arrangement 20 may also be requested by the VMM module 400. In some examples, there may be a B-matrix indicative of how the suspension forces of the suspension arrangement 20 can be allocated/coordinated. The B-matrix may be obtained as part of the suspension capabilities, e.g., as in action 301.

As an example, when the vehicle 1 is a vehicle with 4 wheels and 4 suspension corners, a relation v=Bu. Bu is the B-matrix. U is a vector of actuator action, in these examples suspension actuation. The B-matrix may be defined as:

$$B = [ \begin{matrix}1 & 1 & 1 & 1 ; & Lf 11 & Lf 12 & Lr 13 & Lr 14 & Twf / 2 & Twf / 2 & Twf / 2 & Twf / 2\end{matrix} ]$$

Lf is a length to front axle from a Center of Gravity (COG).
Lr is a length to a rear axle from the COG.
Twf is a track width on the front axle.
Twr is a track width on the rear axle.
The runtime interface, e.g., iXSUSR, provides u by:
ui=FzReqi
FzReqi is a vertical load request on each respective suspension.

Thus when ui=FzReqi, Fz is the defined actuator action.

Now, at the wagon level of the vehicle 1, it may be possible, e.g., by the processor device 602 and/or using the VMM module 400 and/or the suspension runtime interface 405, allocating the requested v forces, moments, and/or vertical loads, either through a simple pseudo inverse or optimized e.g., through Quadratic Programming (QP), by setting it up as a control allocation problem.

Maximum forces and/or torque can now be verified and/or determined using the following equations:

$$\begin{matrix}v\_max = B * u\_max \\ v\_min = B * u\_min\end{matrix}$$

v_max is obtained from u_max which is the maximum actuation action achievable by the actuator.
v_min is obtained from u_min which is the minimum actuation action achievable by the actuator.

Here, u_min and u_max can be obtained via iXSUSR, e.g., the suspension runtime interface 405.

Similarly, a speed control may be used in a corresponding manner using a speed/propulsion runtime interface, e.g., for requesting speed and/or propulsion and/or capabilities relating to the speed and/or propulsion.

In the context of the system comprising the VMM module 400 e.g., for an improved startability of the vehicle 1, the following process may be taken, e.g., as an alternative embodiment of actions 301-307, e.g., performed by the processor device 602, e.g., by use of the VMM module and/or by issuing requests to the suspension runtime interface 405:
451) lowering a chassis level of the vehicle 1 to a bottom level,
452) raising a rear axle suspension of the vehicle 1 using an iXSUSR-request of vertical forces in the suspension arrangement 20,
453) limiting suspension capabilities of a maximum vertical force level and a duration in which it is available, e.g., which may be limited by a bumpstop of a suspension height levelling which is part of capabilities communicated by iXSUSR,
454) add a propulsion longitudinal force to the vehicle 1, e.g., to the wheels of the driving axle 10 of the vehicle 1,
455) if startability is successful, e.g., vehicle has a speed above a predefined threshold, then levelling the chassis heights to a normal, e.g., predefined level.
456) Else, repeating step 451-455.

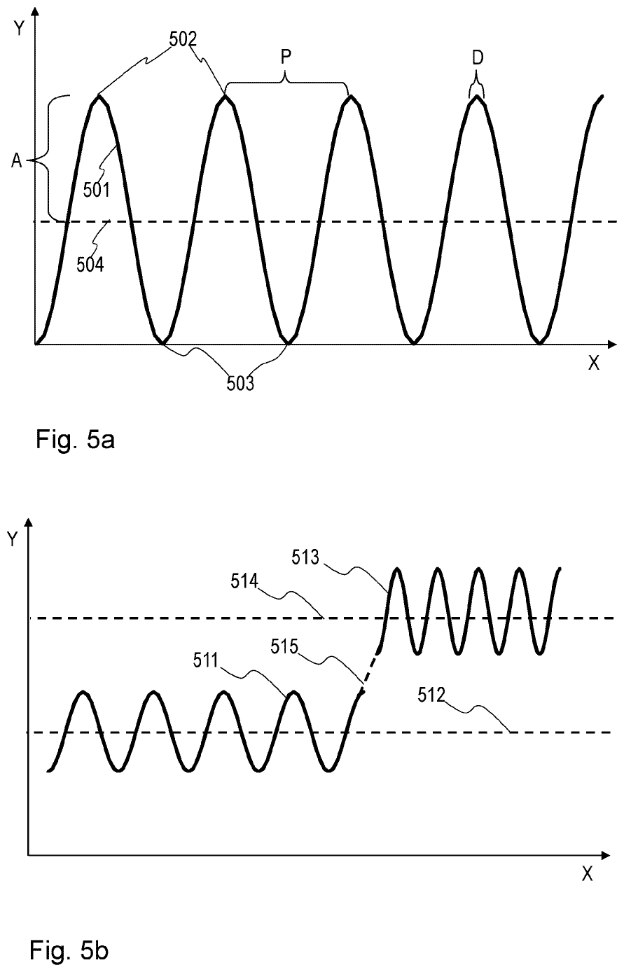

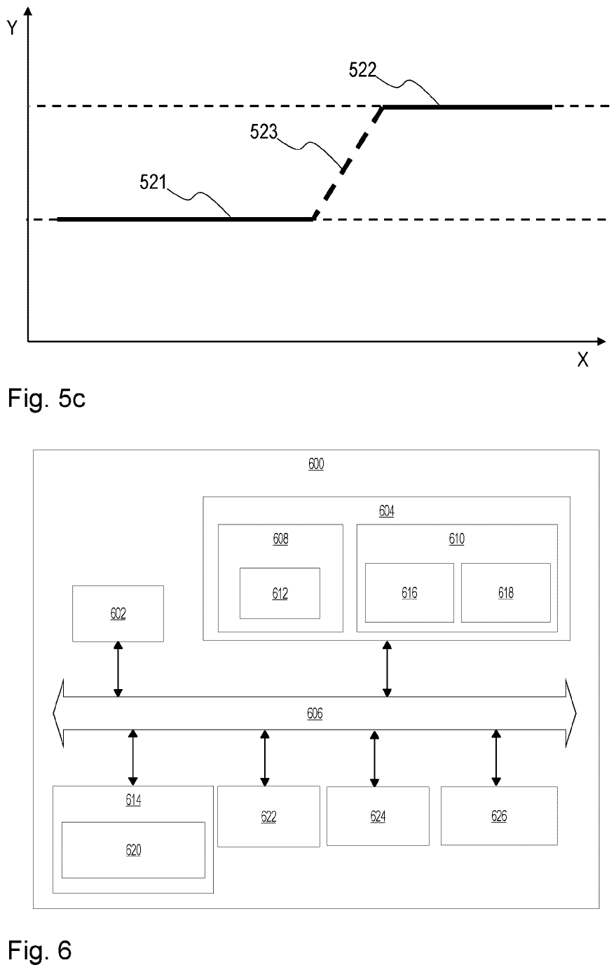

FIG. 5a is a line diagram illustrating a function of time 501 as discussed with respect to above actions 304. The X-axis defines a time, and the Y-axis defines an increased vertical load to be applied by the suspension arrangement 20 to the driven axle, e.g., as in action 304. Alternatively, the Y-axis defines an alternative parameter for applying the increased vertical load, such as e.g., an opening time for a control valve controlling the flow of pressurized air in the suspension arrangement 20. In FIG. 5a, the function of time is a sine wave, however, any other suitable function applies, e.g., another periodic function, e.g., a pulse wave such as a rectangular function, saw tooth function, and/or any suitable variations thereof.

The function of time 501 comprises multiple crests 502.

The function of time 501 comprises multiple troughs 503.

The function of time 501 comprises a time period P, i.e. the time between two crests. The time period P may be the cycle of the function of time 501. The time period P may further define a frequency of the function of time 501.

The function of time 501 comprises an amplitude A. The amplitude A corresponds to half the difference between a crest 502 and a through 503.

The function of time 501 comprises a duration D. The duration D defines how long a maximum part of the function of time is applied. In FIG. 5a, the function is a sine wave and may therefore have a small duration. However, if the function of time is a pulse wave or other suitable function, the duration may be longer.

When the function of time 501 is used to apply an increased vertical load, e.g., as in action 304, as the function varies, an average increase in vertical load 504 will be a resulting vertical load. As there is average increase in vertical load, improved traction follows.

When there is a need to repeat the steps, e.g., as in action 307, e.g., due to determining that the vehicle is not following the start strategy, e.g., the vehicle 1 is still standstill, the function of time as described in FIG. 5a and used in the suspension control step 304 may need to be updated, e.g., to have a higher average value in vertical load to improve the traction of the start strategy. The function of time may also need to be adjusted or updated with respect to frequency, period, amplitude etc.

FIG. 5b illustrates an example where a first iteration of the suspension control step 304 issues suspension operation information to the vehicle 1 to operate the suspension arrangement 20 in accordance with the suspension capabilities to increase the vertical load applied such that the vertical load applied to said driven axle varies in accordance with a first function of time 511 resulting in a first average increase in vertical load 512.

When there is a need to repeat the steps, e.g., as in action 307, a new iteration of actions 301-307 may be performed.

A second iteration of the suspension control step 304 then issues suspension operation information to the vehicle 1 to operate the suspension arrangement 20 in accordance with the suspension capabilities to increase the vertical load applied such that the vertical load applied to said driven axle 10 varies in accordance with a second function of time 513 resulting in a second average increase in vertical load 514. The second average increase in vertical load 514 being higher, i.e., of increased vertical load, than the first average increase in vertical load 512. As the average load is increased in the second iteration, the second function of time 513 may be shorter in time than the first function of time. This is since more suspension capabilities may be used for the increased average vertical load.

The second function of time 513 may be a new function of time separate from the first function of time 511, or an adapted version of the first function of time 511.

The second function of time 513 may have different characteristics than the first function of time 511, e.g., any one or more out of: different amplitude, different period, different crests and troughs, different duration, different frequency, and different average value.

In this example, to bridge the first and second iteration, the increase in vertical load may be applied when possible, e.g., by a transition function 515.

FIG. 5c illustrates an example where a first iteration of the suspension control step 304 issues suspension operation information to the vehicle 1 to operate the suspension arrangement 20 in accordance with the suspension capabilities to increase the vertical load applied such that the vertical load applied to said driven axle varies in accordance with a first constant function of time 521 which is associated with the suspension arrangement 20 applying a constant increased vertical load for a first period of time.

When there is a need to repeat the steps, e.g., as in action 307, a new iteration of actions 301-307 may be performed.

A second iteration of the suspension control step 304 issues suspension operation information to the vehicle 1 to operate the suspension arrangement 20 in accordance with the suspension capabilities to increase the vertical load applied such that the vertical load applied to said driven axle varies in accordance with a second constant function of time 522 which is associated with the suspension arrangement 20 applying a constant increased vertical load for a second period of time. The second constant function of time 522 being associated with the suspension arrangement 20 applying an increased vertical load than the first constant function of time 521. As the load is increased in the second iteration, the second period of time of the constant function of time 522 may be shorter in time than the first period of time of the first constant function of time 522. This is since more suspension capabilities may be used for the increased vertical load.

In this example, to bridge the first and second iteration, the increase in vertical load may be applied when possible, e.g., by a transition function 523.

The second constant function of time 522 may be a new function of time separate from the first constant function of time 521, or an adapted version of the first constant function of time 521.

FIG. 6 is a schematic diagram of a computer system 600 for implementing examples disclosed herein. The computer system 600 is adapted to execute instructions from a computer-readable medium to perform these and/or any of the functions or processing described herein. The computer system 600 may be connected (e.g., networked) to other machines in a LAN, an intranet, an extranet, or the Internet. While only a single device is illustrated, the computer system 600 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, etc., includes reference to one or more such devices to individually or jointly execute a set (or multiple sets) of instructions to perform any one or more of the methodologies discussed herein. For example, control system may include a single control unit, or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 600 may comprise at least one computing device or electronic device capable of including firmware, hardware, and/or executing software instructions to implement the functionality described herein. The computer system 600 may include a processor device 602 (may also be referred to as a control unit), a memory 604, and a system bus 606. The computer system 600 may include at least one computing device having the processor device 602. The system bus 606 provides an interface for system components including, but not limited to, the memory 604 and the processor device 602. The processor device 602 may include any number of hardware components for conducting data or signal processing or for executing computer code stored in memory 604. The processor device 602 (e.g., control unit) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor device may further include computer executable code that controls operation of the programmable device.

The system bus 606 may be any of several types of bus structures that may further interconnect to a memory bus (with or without a memory controller), a peripheral bus, and/or a local bus using any of a variety of bus architectures. The memory 604 may be one or more devices for storing data and/or computer code for completing or facilitating methods described herein. The memory 604 may include database components, object code components, script components, or other types of information structure for supporting the various activities herein. Any distributed or local memory device may be utilized with the systems and methods of this description. The memory 604 may be communicably connected to the processor device 602 (e.g., via a circuit or any other wired, wireless, or network connection) and may include computer code for executing one or more processes described herein. The memory 604 may include non-volatile memory 608 (e.g., read-only memory (ROM), erasable programmable read-only memory (EPROM), electrically erasable programmable read-only memory (EEPROM), etc.), and volatile memory 610 (e.g., random-access memory (RAM)), or any other medium which can be used to carry or store desired program code in the form of machine-executable instructions or data structures, and which can be accessed by a computer or other machine with a processor device 602. A basic input/output system (BIOS) 612 may be stored in the non-volatile memory 608 and can include the basic routines that help to transfer information between elements within the computer system 600.

The computer system 600 may further include or be coupled to a non-transitory computer-readable storage medium such as the storage device 614, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 614 and other drives associated with computer-readable media and computer-usable media may provide non-volatile storage of data, data structures, computer-executable instructions, and the like.

A number of modules can be implemented as software and/or hard-coded in circuitry to implement the functionality described herein in whole or in part. The modules may be stored in the storage device 614 and/or in the volatile memory 610, which may include an operating system 616 and/or one or more program modules 618. All or a portion of the examples disclosed herein may be implemented as a computer program product 620 stored on a transitory or non-transitory computer-usable or computer-readable storage medium (e.g., single medium or multiple media), such as the storage device 614, which includes complex programming instructions (e.g., complex computer-readable program code) to cause the processor device 602 to carry out the steps described herein. Thus, the computer-readable program code can comprise software instructions for implementing the functionality of the examples described herein when executed by the processor device 602. The processor device 602 may serve as a controller or control system for the computer system 600 that is to implement the functionality described herein.

The computer system 600 also may include an input device interface 622 (e.g., input device interface and/or output device interface). The input device interface 622 may be configured to receive input and selections to be communicated to the computer system 600 when executing instructions, such as from a keyboard, mouse, touch-sensitive surface, etc. Such input devices may be connected to the processor device 602 through the input device interface 622 coupled to the system bus 606 but can be connected through other interfaces such as a parallel port, an Institute of Electrical and Electronic Engineers (IEEE) 1394 serial port, a Universal Serial Bus (USB) port, an IR interface, and the like. The computer system 600 may include an output device interface 624 configured to forward output, such as to a display, a video display unit (e.g., a liquid crystal display (LCD) or a cathode ray tube (CRT)). The computer system 600 may also include a communications interface 626 suitable for communicating with a network as appropriate or desired.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A computer-implemented method for starting a standstill vehicle in accordance with a start strategy, said vehicle having a vehicle longitudinal extension in a vehicle longitudinal direction and a vehicle vertical extension in a vehicle vertical direction, wherein said vehicle longitudinal direction corresponds to an intended direction of travel of said vehicle when travelling straight ahead, said vehicle vertical direction corresponding to a direction of a normal to a planar surface supporting the vehicle, the computer-implemented method comprising:
by a processor device of a computer system, obtaining suspension capabilities of a suspension arrangement in the vehicle, the suspension capabilities being indicative of at least a maximum vertical load, in said vertical direction, that can be applied to a driven axle of the vehicle,
a) by the processor device, in a suspension control step, issuing suspension operation information to the vehicle to operate the suspension arrangement in accordance with the suspension capabilities to increase the vertical load applied to said driven axle of the vehicle, wherein the suspension control step comprises operating the suspension arrangement in accordance with the suspension capabilities to increase the vertical load applied such that the vertical load applied to said driven axle varies in accordance with a function of time, and wherein, the vertical load applied to said driven axle varies as a function of time with a time period such that a vertical load function with crests and troughs is obtained, and wherein the time period is dependent on an actuation rate of the suspension arrangement;
b) by the processor device, in a propulsion control step, issuing propulsion control information to the vehicle to apply a propulsion longitudinal force, in said longitudinal direction, on the wheels of the driven axle of the vehicle,
in response to detecting that the vehicle does not follow the start strategy, repeating the suspension control step and the propulsion control step.

2. A computer system comprising the processor device configured to perform the method of claim 1.

3-5. (canceled)

6. The method of claim 1, wherein the function of time is associated with an amplitude of vertical load to apply to said driven axle, the amplitude corresponding to half the difference in vertical load between a crest load at one of the crests and a trough load at one of the troughs.

7. The method of claim 6, wherein the amplitude is based on a minimum amplitude needed to apply an increased vertical load to said driven axle.

8. The method of claim 6, wherein the function of time is indicative of a duration for how long to apply the increased vertical load to said driven axle.

9. The method of claim 6, wherein the function of time is associated with an average value being the average of the vertical load applied to the vertical load applied to said driven axle, wherein said suspension control step comprises increasing the average value.

10. The method of claim 9, when, wherein said suspension control step comprises maintaining the amplitude when issuing suspension operation information to the vehicle to operate the suspension arrangement in accordance with the suspension capabilities to increase a vertical load applied to said driven axle of the vehicle.

11. The method of claim 6, wherein the function of time is a predefined function of time.

12. The method of claim 6, wherein the method further comprises determining the function of time based on any one or more of:
a load of the vehicle,
an indication of whether or not the vehicle is attached to a trailer,
a surface type of the ground supporting ground engaging members, such as wheels, associated with said driven axle, and
the suspension capabilities and/or an indication of a type of suspension in the suspension arrangement.

13. The method of claim 6, wherein issuing suspension operation information to the vehicle to operate the suspension arrangement comprises issuing suspension operation information to control a flow of pressurized air of the suspension arrangement in accordance with the function of time.

14. The method of claim 6, wherein said propulsion control step comprises applying the propulsion longitudinal force on the wheels of the driven axle of the vehicle based on the function of time.

15. The method of claim 1, further comprising:
prior to any one or both of the suspension control step and the propulsion control step, issuing lowering information to the vehicle, to trigger a lowering of a chassis of the vehicle.

16. The method of claim 1, wherein the vehicle is attached to a trailer, and the method further comprising:
by the processor device, prior to any one or both of the suspension control step and the propulsion control step, issuing trailer suspension operation information to the trailer to operate a suspension arrangement of the trailer to impose an increased vertical load on said driven axle of the vehicle.

17. The method of claim 1, the suspension capabilities further being indicative of a time duration during which a certain vertical load is allowed to be applied to the driven axle of the vehicle.

18. The method of claim 1, wherein issuing the suspension operation information to the vehicle in the suspension control step, and/or wherein obtaining the suspension capabilities is performed by issuing respective requests to a suspension runtime interface of the vehicle.

19. The method of claim 1, wherein said start strategy comprises that the vehicle moves at a speed being equal to or exceeding a predetermined threshold speed, preferably said predetermined threshold speed is in the range of 5-15 km/h.

20. A vehicle comprising a processor device to perform the method of claim 1.

21. The vehicle according to claim 20 wherein the vehicle is attached to a trailer, and wherein the processor device is capable of controlling a suspension arrangement of the trailer.

22. A computer program product comprising program code for performing, when executed by the processor device, the method of claim 1.

23. (canceled)

24. A non-transitory computer-readable storage medium comprising instructions, which when executed by the processor device, cause the processor device to perform the method of claim 1.
